(19) United States
(12) Patent Application Publication
(10) Pub. No.: US 2010/0281173 A1
(43) Pub. Date: Nov. 4, 2010

(54) DELEGATED ADMINISTRATION FOR REMOTE MANAGEMENT

(75) Inventors: Krishna Chythanya Vutukuri, Redmond, WA (US); Hitesh U. Raigandhi, Redmond, WA (US); Narayanan Lakshmanan, Bothell, WA (US); Wassim S. Fayed, Sammamish, WA (US); Jeffrey P. Snover, Woodinville, WA (US); Kenneth M. Hansen, Woodinville, WA (US); Evan T. Dodds, Seattle, WA (US); Vladimir V. Grebenik, Redmond, WA (US); Paul C. Allen, Kirkland, WA (US); Vishwajith Kumbalimutt, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/433,916

(22) Filed: May 1, 2009

(51) Int. Cl. G06F 21/00; G06F 15/16

(52) U.S. Cl. 709/228; 726/4

(57) ABSTRACT

A remote administration system is described herein that provides varying permissions to invoke administrative commands to multiple users. An application host provisions users of different organizations and defines one or more commands that the users can invoke remotely. The system associates the commands with users and/or groups to specify the users and/or groups that are authorized to execute the commands. When the remote administration system receives a remote request to perform a command, the system determines a user associated with the command and whether the user is authorized to execute the command. The system also creates an execution context for each connected user that defines the roles and access privileges associated with the user and that isolates the user from other users. Thus, the remote administration system provides remote administration of hosted applications in a way that is easy for administrators of the hosted service to manage.

### BACKGROUND

An application service provider (ASP) is a business that provides computer-based services to customers over a network. Software offered using an ASP model is also sometimes called on-demand software or software as a service (SaaS). The most limited sense of this business is that of providing access to a particular application program (such as a customer relationship management (CRM) application) using a standard protocol such as Hypertext Transfer Protocol (HTTP). The reasons for ASPs have evolved from the increasing costs of specialized software that have far exceeded the price range of small to medium sized businesses to the growing complexities of software that have led to huge costs in distributing software to end-users. Through ASPs, administrators can cut down the complexities and costs of such software. In addition, end users no longer have issues such as upgrading by placing the onus on the ASP to maintain up-to-date services, 24×7 technical support, physical and electronic security, and built-in support for business continuity and flexible working. Clients for ASP services include businesses, government organizations, non-profits, and membership organizations.

Once an application shifts from a data center under an organization's control to a data center “in the cloud” that is only accessible over a network, the application is remotely managed by administrators or other information technology (IT) workers associated with the organization. For example, even though an ASP may provide a hosted email service and ensure that the service is operational and has all of the latest patches, it is still up to IT workers of the organization using the ASP to add mailboxes, remove mailboxes, manage quotas, and so forth. Most applications, whether running locally or remotely, provide some type of administration service through which administrators can modify configuration settings (e.g., through either a graphical user interface (GUI) or console user interface (CUI)). Some environments provide a common architecture for accessing administration services, such as Microsoft Windows Power Shell. Power Shell exposes cmdlets that are custom defined Microsoft .NET classes that implement a particular administrative operation. Cmdlets can be invoked using simple text strings (e.g., “get-process”) with zero or more text-based parameters. Administrators can write scripts that invoke one or more cmdlets to perform complex tasks. Applications can embed Power Shell to provide management of the application through the Power Shell hosting application-programming interface (API), such as Microsoft Exchange 2007 does.

When an administration service is running locally on a computer system, access to various commands of the administration service can generally rely on the identity of the logged in user that invokes the command to determine whether the service permits the user to perform various actions. Thus, the user's token is available directly and provides the user's access permissions. If multiple users log onto the same system, each user will have both an independent process and his/her own token and related access permissions associated with the process. When an administration services runs remotely, the service often runs in a single process that receives requests from many users, each of which may have a different level of access to the service. Checking access levels upon receiving every single command is inefficient and wastes resources of the service. In addition, the service may want to restrict what commands users of a low access level can even view, much less invoke.

### SUMMARY

A remote administration system is described herein that provides varying permissions to invoke administrative commands to multiple users, regardless of a process in which the system runs. Using the system, an ASP administrator provisions users of different organizations that have applications hosted by the ASP into roles. The system defines one or more tasks and exposes the tasks as commands that users can invoke remotely. The system associates the commands with users and/or groups to specify the users and/or groups that are authorized to execute the commands. When the remote administration system receives a remote request to perform a command, the system determines a user associated with the command. The system may run in a single process, but creates an execution context for each connected user that defines the roles and access privileges associated with the user and isolates the user from other users. As the system receives subsequent command from the user, the system can operate similar to a local administration service and accept or deny commands from the user based on the execution context. Access to commands in this way allows the ASP to delegate authority in an orderly manner that reduces the management burden on the ASP. Thus, the remote administration system provides remote administration of hosted applications in a way that defines administrative abilities of each user and that is easy for administrators of the hosted service to manage.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of the remote administration system, in one embodiment.

FIG. 2 is a block diagram that illustrates an operating environment of the remote administration system, in one embodiment.

FIG. 3 is a flow diagram that illustrates the processing of the system to define authorization information, in one embodiment.

FIG. 4 is a flow diagram that illustrates the processing of the system to handle commands from a remote session, in one embodiment.

### DETAILED DESCRIPTION

A remote administration system is described herein that provides varying permissions to invoke administrative commands to multiple users, regardless of a process in which the system runs. In some embodiments, the system is integrated with a common architecture for accessing administration services, such as Microsoft Windows Power Shell, to provide administration that was previously only available locally on an application server to any computer that can access the application server remotely over a network. Using the system, an ASP administrator provisions users of different organizations that have applications hosted by the ASP into roles. For example, a hosted Microsoft Exchange service may host mailboxes for company A and company B, create users manager A and manager B for each company, and add the users to a new role “managers.” The system defines one or more tasks and exposes the tasks as commands (e.g., cmdlets). For example, an email server may have tasks to perform actions, such as “create mailbox” and “delete mailbox” that allow adding and removing mailboxes, for example. The system associates the commands with users and/or groups to specify the users and/or groups that are authorized to invoke the commands to execute the relevant operations. For example, a managers role may have access to create mailboxes, but a data backup role may not. In addition, the system may allow the administrator to restrict the capabilities of each command based on users and roles, so that the system will not accept certain parameters or parameter values from users or roles without sufficient privileges. This allows the administrator a fine granularity of control over how users of an organization can access administrative commands provided by the remote administration service.

When the remote administration system receives a remote request to perform a command, the system determines a user associated with the command. For example, the user may first log onto the system by connecting to a server hosting the service and providing authentication information, such as a username and password. The system may run in a single process, but creates an execution context for each connected user that defines the roles and access privileges associated with the user. For example, the system may create a thread for each connected user and use impersonation to define a token for the thread related to the user's access privileges. As the system receives subsequent command from the user, the system can operate similar to a local administration service and accept or deny commands from the user based on the execution context. In addition, if the user issues commands that list available commands and parameters, the system restricts the results based on the user's access privileges to display to the user only those commands and parameters accessible to the user. Access to commands in this way allows the ASP to delegate authority in an orderly manner that reduces the management burden on the ASP. For example, an ASP administrator may grant a user in each organization privileges to administer that organization's application data, then an administrator of each organization may grant one or more users privileges to perform limited tasks, and so forth down a chain of administrative authority. Thus, the remote administration system provides remote administration of hosted applications in a way that defines administrative abilities of each user and that is easy for administrators of the hosted service to manage. An administrator can even confidently give limited, scriptable management capabilities to each user, such as to view settings of that user's own data (e.g., a mailbox quota or size remaining) and create new data (e.g., a distribution list for a manager's team).

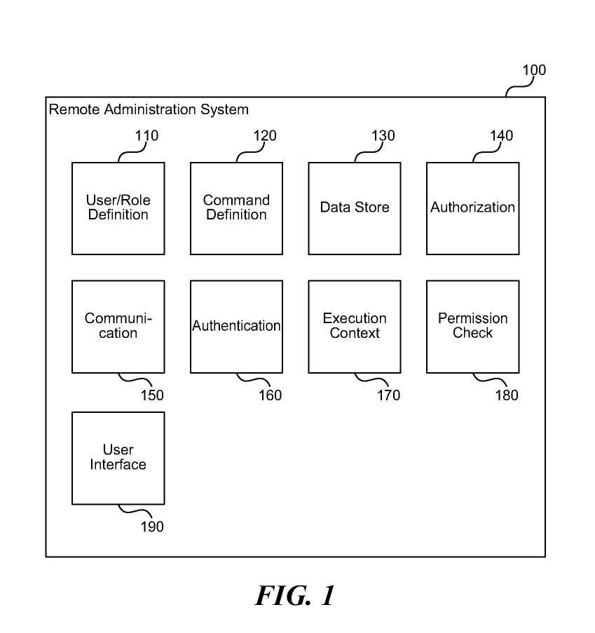

FIG. 1 is a block diagram that illustrates components of the remote administration system, in one embodiment. The system 100 includes a user/role definition component 110, a command definition component 120, a data store component 130, an authorization component 140, a communication component 150, an authentication component 160, an execution context component 170, a permission check component 180, and a user interface component 190. Each of these components is described in further detail herein.

The user/role definition component 110 allows an administrator or application to define one or more users and/or roles that can access the system to invoke commands. A role is a group that contains zero or more users and to which the system can assign any permissions that can be assigned to an individual user. Users may include various members of an organization with varying levels of access to invoke commands of the system.

The command definition component 120 allows an administrator to define one or more commands or requested actions that perform administrative tasks related to a hosted application. The commands may include informational commands that retrieve information or data (e.g., list users, display disk usage, and so forth), modification commands that change, create, and/or update, for example, properties of existing objects (e.g., increase quota, change backup schedule, and so on), creation/deletion commands that add and remove new objects (e.g., add a mailbox for new employee, delete a file share for a departing employee, and so forth), and commands for the invoking of methods for execution. Each command may include information identifying an executable module that the system 100 invokes in response to a user invoking the command. The command may also include one or more parameters that the system receives from the user and provides to the executable module to modify the behavior of the command.

The data store component 130 is a storage device that persists information about users, roles, and commands across user sessions with the system. For example, the data store component 130 may include a database, file, or other common storage paradigm that allows the system to maintain data about users, roles, and commands.

The authorization component 140 receives and stores a mapping of users and roles to commands and parameters, according to embodiments. In an embodiment, an authorization is created that depends on the operations to be carried out, i.e., executed, such as the retrieving of data, modifying of data, and invoking of methods for execution. An administrator or other user defines which commands a particular user can access. For example, a standard user may be able to view information about the user's mailbox on an email server, but not create new mailboxes. The authorization component 140 also receives mappings that restrict the parameters or parameter values that can be used. For example, a manager may be allowed to create new mailboxes, but not with a quota size larger than a certain size (e.g., 100 megabytes). The definitions may specify single users (e.g., like an access control list (ACL)) or roles that include one or more users (e.g., a database backup role, an email administrator role, and so on). Roles simplify management of a service by allowing an administrator to focus on which users are assigned to each role rather than explicitly assigning each user to commands to which that user has access. Once an administrator has defined an appropriate set of roles for the administrator's organization and defined commands and properties available to each role, new users can be granted or denied access by modifying role membership without modifying each command.

The communication component 150 provides operations to prepare communications for sending and receiving over a network. For example, the system may be implemented on top of HTTP using the Simple Object Access Protocol (SOAP)-based WS-Management protocol. WS-Management is a standards-compliant management protocol built on top of Transmission Control Protocol/Internet Protocol (TCP/IP). The communication component 150 operates at a client to serialize and packetize client requests, send them to a server, and unpack/deserialize responses for display at the client. In embodiments, the requests or commands are first encoded. The data portion of the encoded messages are then serialized as XML, for example. The serialized XML is then fragmented prior to transport of the message to a server. The communication component 150 also operates at the server side to unpack/deserialize client requests, provide them to other server components, receive responses, and serialize the responses for transmission to the client. The communication component 150 can use any suitable communication protocol and/or data transmission format. In addition, the communication component 150 may use local inter-process communication options for sending data to multiple processes running on a single server or client. This may be useful for testing or other scenarios.

The authentication component 160 authenticates user sessions based on credentials supplied by the client. For example, the authentication component 160 may support various common authentication schemes includes Kerberos, Negotiate, and Identity Management services (like Microsoft Live ID). Each of these authentication schemes provide the component 160 with assurance that a user attempting to connect to the system is who the user identifies himself/herself to be. The authentication component 160 may operate at the first request to authenticate the user and create a session (e.g., associated with a ticket, token, or other authentication result) that the user can provide for subsequent requests to demonstrate successful authentication to the system.

The execution context component 170 creates and manages one or more execution contexts that provide an isolation environment associated with each user connected to the system. After a user connects to the system and establishes a session, the system creates an execution context associated with the user that identifies the user and the commands and other privileges associated with the user. The execution context component 170 isolates each user and each user's privileges from those of other users. The execution context provides a manageable connection to the system that an administrator can terminate to disconnect a user from the system.

The permission check component 180 validates received client requests against authorization information to verify that a user has the authority to perform a requested action. In embodiments, the authorization to perform an action depends on the operation(s) to be executed, e.g., retrieval of data, modification of data, and/or invoking of methods. For example, in response to receiving a request, the system may verify that one or more commands in the request are on a list of commands the user is authorized to invoke. The system may create and associate the list of commands with the user's execution context after the user connects to the system. The permission check component 180 may also verify that the user is authorized to specify command parameters and language constructs specified in a received request.

The user interface component 190 provides an interface for receiving commands from a user and providing results in response to commands to the user. The user interface component 190 may include multiple interfaces through which a user can connect to the system, including a GUI, CUI, web service API, and so forth. The user interface component 190 may include an executable program that runs at a client component to receive commands from a user and transmits the commands to a server for processing. The user interface component 190 may also import information previously prepared by the user or someone else, such as information stored in a file.

The computing device on which the remote administration system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

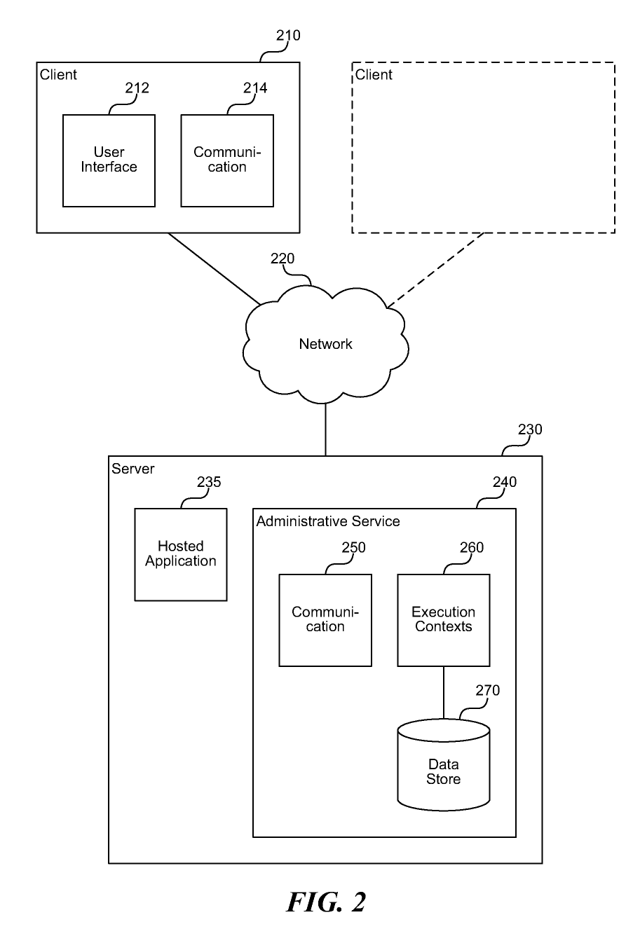

FIG. 2 is a block diagram that illustrates an operating environment of the remote administration system, in one embodiment. The diagram includes a client 210, a network 220, and a server 230. The system may operate on multiple clients and multiple servers (not shown) at the same time. The components described herein may be distributed in various ways between the client and the server. For example, in the diagram the client 210 includes a user interface component 212 and a communication component 214. The user interface component 212 receives commands from a user and uses the communication component 214 to package the commands and send them over the network 220 to the server 230. The network 220 may include the Internet, a Local Area Network (LAN), or any other type of connection between the client 210 and server 230.

The server 230 includes a hosted application 235 and an administrative service 240 for administering the hosted application 235. The hosted application 235 may include many types of applications provided by ASPs, including an email server, web server, database server, a CRM application, and so forth. The administrative service 240 contains various components of the system described herein, including a communication component 250 to deserialize information received from the client, an execution context component 260 managing one or more execution contexts, and a data store 270 that stores user information, command information, and authorization information.

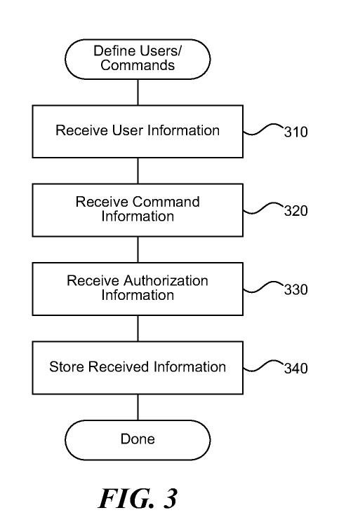

FIG. 3 is a flow diagram that illustrates the processing of the system to define authorization information, in one embodiment. Beginning in block 310, the system receives information about one or more users of the system. An ASP administrator may provision users of different organizations. For example, a hosted database service may host databases for one or more companies and provide an administrative user account through which each company can manage its databases. The user information may also include one or more roles and users associated with each role. For example, an administrator may define a role for auditing the system that can read all information but not modify anything. Continuing in block 320, the system receives command information that includes a module that implements each command and any parameters of the command. For example, the system may receive cmdlets for an email server that include commands for listing mailboxes, creating mailboxes, and removing mailboxes.

Continuing in block 330, the system receives authorization information that, in embodiments, creates relationships between the received users and the received commands. In embodiments, the authorization to perform an action depends on the operation(s) to be executed, e.g., retrieval of data, modification of data, and/or invoking of methods for execution. For example, one user may be authorized to delete mailboxes on an email server, while another user is authorized only to list mailboxes. In an embodiment, the system associates the commands with users and/or groups to specify the users and/or groups that are authorized to invoke the commands for the execution of operations. For example, a managers role may have access to create mailboxes, but a data backup role may not. In addition, the system may allow the administrator to restrict the capabilities of each command based on users and roles, so that the system will not accept certain parameters or parameter values from users or roles without sufficient privileges. This allows the administrator a fine granularity of control over how users of an organization can access administrative commands provided by the remote administration service.

Continuing in block 340, the system stores the received information for later retrieval in response to received requests from users. A user connects to the system and provides authentication information that identifies the user. In response, the system sets up an execution context with information about the commands and parameters that the user is authorized to invoke based on the received authorization information and any roles to which the user belongs. After block 340, these steps conclude.

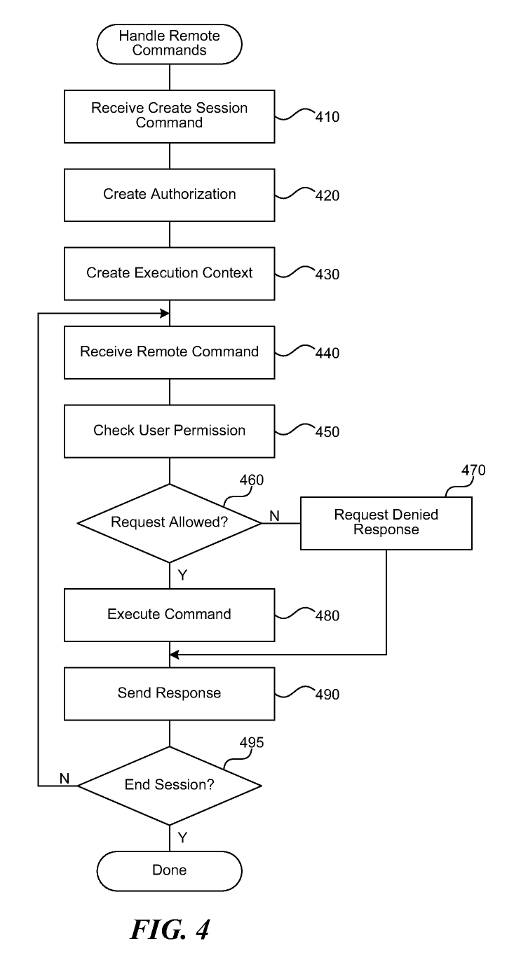

FIG. 4 is a flow diagram that illustrates the processing of the system to handle commands from a remote session, in one embodiment. Beginning in block 410, the system receives a new connection request that, in embodiments, includes authentication information. For example, a user may connect from a client console by specifying a command such as “new-psession -uri exchlabs.com -credential user password.” In this example, the user is creating a remote session by specifying the server to which to connect using a Uniform Resource Identifier (URI) (e.g., exchlabs.com) and credentials that include a username and password. The user can specify the server in other ways, such as by providing an Internet Protocol (IP) address. The user can also specify credentials in many ways, including using a certificate, Live ID, or other authentication technique. In response to the user executing this command, the system receives the request at the server and authenticates the user based on the specified credentials.

Continuing in block 420, the system creates an authorization. In embodiments, this authorization depends on the operations to be carried out, i.e., executed, such as retrieving data, modifying data, and/or invoking methods for execution. In further embodiments, this authorization includes a list of allowed commands and parameters based on an identity of the user. The system determines the roles of which the user is a member and determines the commands and parameters that the user is allowed to access based on the user's identity and roles. The system stores the command list (e.g., in memory, a database, or a file) so that the system can access the list for each command that the user executes during the lifetime of a session associated with the connection. Continuing in block 430, the system creates a run space or execution context that includes the created authorization or created list of commands and information about the new session, such as the identity of the user associated with the session. The execution context may set up impersonation so that commands invoked by the user will run as a particular user on the server. For example, an ASP may create a user account for each organization that has access to only that organization's data and run any commands from users of that organization as the organization user. This process ensures a level of isolation between organizations hosted on the same server.

Continuing in block 440, the system receives a request from the user that includes a command that the user requests be performed, such as retrieving data, modifying data, and/or invoking methods for execution. For example, the user may specify a command at a console such as “invoke-command $s {(cmds)}” where invoke-command is a local command on the client that indicates that the user wants to execute a remote command, $s is a variable holding information about a session from a previous command that created the session, and “cmds” is a list of one or more remote commands to execute along with any specified parameters. The system may also provide a “get-commands” command through which the user can discover the contents of the list of allowed commands. When a user sends a command from the client, the client packages/serializes the command to a data structure for sending over the network, sends the data structure over the network to the server, and receives a response. The server unpacks/deserializes the command, executes the command, and returns the results to the client (reserializing as needed).

Continuing in block 450, the system verifies that the user has permission to execute the received command. For example, the system may consult the authorization or list of allowed commands created earlier when the user first connected. The verification may also include verifying whether the user is allowed to use parameters specified by the user in the received request. Because the authorization or list is created when the user connects, according to embodiments, the system can quickly determine whether to allow the user to execute the command without additional qualification of the user's roles or other information. Continuing in decision block 460, if the system determines that the user is allowed to execute the received request, then the system continues at block 480, else the component continues in block 470. Determining that a user is allowed to execute the received request may comprise checking both the command and the parameters of the request. If either fails, then the component continues at block 470.

Continuing in block 470, the system responds to the received request with an error message indicating that the user is not authorized to execute the request. The response may also include return value information that the client can inspect within a script in which the command may be running, so that the script can take appropriate action upon failure to execute a command. After block 470, the system continues at block 490. Continuing from block 460 in block 480, the system executes the received command to perform the requested action. Executing the command may include providing the command to a component of the system hosted within an application's process to perform administrative tasks offered by the application. For example, a Microsoft Exchange server may include a module that runs within its process to receive administrative commands and perform tasks associated with the commands by invoking other parts of the application.

Continuing in block 490, the system sends a response to the received command based on results of executing the received command. For example, a command that requests a list of data may receive the requested list from the application, package the list for transmission to the client, and send the list to the client for display to the user. Continuing in block 495, if the users requests to end the session, then the system completes, else the system loops to block 440 to receive the next command. For example, a user may specify an “end-session” command that closes the session or may keep the session open and continue executing additional commands. After block 495, these steps conclude.

In some embodiments, the remote administration system allows an administrator or other user to assign quota limits to users. For example, the administrator may restrict the number of commands a user can run per minute. Quotas are another form of verifying that the ways in which a user uses the system are in accordance with an administrator's expectations. For example, an administrator may not expect a single organization to create more than 1,000 mailboxes per hour, and can use quotas to specify and enforce this expectation.

In some embodiments, the remote administration system provides an alternate location to service a user request. For example, if a server is down for maintenance the administrator may provide an alternate location that can still service some commands. As another example, the administrator may obscure the topology of a network service or provide load balancing by providing a single initial server to which each administrative user connects before the system redirects the user to the actual server hosting that user's application.

In some embodiments, the remote administration system allows an administrator to restrict language elements provided by the system to which users have access. For example, an administrator may prevent a standard user from specifying a “for” language construct in a script. Programming and scripting languages provide common constructs that direct the flow of a program or script, such as “if” statements, “while” statements, “for” loops, and so forth. These constructs can be powerful and allow a user to perform many operations very quickly, but can also be dangerous in the hands of an inexperienced user. Thus, the system allows the administrator to specify users and roles that can access higher-level constructs such as these.

In some embodiments, the remote administration system provides commands to multiple applications on the same server. For example, a server may host a web server and database, and a remote user may connect to the server through a single administrative session to manage both applications. Each application can register its own commands with the remote administration system, and the system makes these commands available remotely as described further herein.

In some embodiments, the remote administration system provides a user with access to administer multiple servers. For example, users may be defined as domain users with an ASPs domain and stored in a directory (e.g., Microsoft Active Directory) accessible by each server (or some subset of servers) in an ASPs data center. Likewise, the system may store roles in a cross-server manner. Thus, a user may be able to connect to any of several servers containing applications hosted by the ASP on the user's behalf, and administer each of the servers and applications as described further herein.

In some embodiments, the remote administration system provides a command executed at the client that allows the user to specify that the system execute subsequent commands using an existing session. For example, a command “import-session $s” may specify that the user wants subsequent commands to run with a session created and stored in the variable $s. This simplifies the subsequent command syntax by allowing the user to run subsequent commands at the remote server as if the user is running the commands locally (e.g., the “invoke-command” syntax described above can be omitted). This allows an administrator that has built up a library of existing scripts for local administration to easily migrate to managing similar applications running remotely using the existing scripts. The administrator adds commands to perform the initial session set up and import, and then runs the remaining commands as the administrator did previously.

In some embodiments, the remote administration system provides commands for an administrator to manage remote connections to an application server. For example, a command “get-wsmaninstance” may allow an administrator to list active remote sessions, along with other information such as a user identifier or other authentication information provided by the user associated with each session. The system may provide other commands, such as “delete-wsmaninstance” for closing a session. This allows an administrator (who may also administer a server locally or remotely) to manage which users are connected to a server and to remove users under certain situations (e.g., server maintenance about to begin).

In some embodiments, the remote administration system receives user and command definitions through an imported file. For example, a “web.config” file associated with a web server may include a list of users, roles, commands, assemblies that implement commands, and so forth that the system imports. This allows an ASP to quickly set up new servers and import existing command and user data in one action without manually administering the server through a user interface. The system also allows an administrator to specify scripts or advanced commands using files. For example, a university may add 3,000 new mailboxes at the beginning of each semester for new students (and delete mailboxes for departing students). Rather than navigate a user interface 3,000 times or run a remote command 3,000 times, the administrator can export a list of new students from a student database to, for example, a comma-separated values (CSV) file. Then, the administrator can run a command such as “import-csv c:\students.csv|new-mailbox” to create all of the student mailboxes. The parameter “c:\students.csv” provides a list of students, the pipe command “|” requests that the system execute the following command for each item in the file, and “new-mailbox” specifies the command to execute. If the administrator previously created and imported a remote session, then the system will run the command on whatever server the administrator specified.

In some embodiments, the remote administration system executes commands that include interleaved remote and local components. For example, a user may specify a command “get-mailbox|sort-object-mailbox” where “get-mailbox” is a command requesting that a remote server list each mailbox stored on the server, and “sort-object-mailbox” is a command requesting local sorting of the resulting list of mailboxes. The pipe command “|” separates the remote and local operations in this example. In some cases, it may be more efficient to perform an operation locally that could be performed either remotely or locally (e.g., sorting a list). An administrator may also have other concerns, such as avoiding overburdening a busy server, that lead to a desire to run a portion of a request locally.

From the foregoing, it will be appreciated that specific embodiments of the remote administration system have been described herein for purposes of illustration, but that various modifications may be made without deviating from the spirit and scope of the invention. Accordingly, the invention is not limited except as by the appended claims.

I/We claim:

1. A computer-implemented method for handling commands from a remote session to administer a hosted service, the method comprising:
receiving a connection request;
creating an authorization for performing an action, wherein the authorization depends on an operation to be executed;
receiving a request from a user that includes a command that the user requests be performed;
verifying that the user has authority to execute the received command based on the created authorization;
in response to determining that the user is authorized to execute the command, executing the received command; and
sending a response to the received command based on results of executing the received command,
wherein the preceding steps are performed by at least one processor.

2. The method of claim 1 wherein receiving a connection request comprises receiving the request at a server associated with a URI specified by the request and wherein the request includes credentials for authenticating a user that initiated the request.

3. The method of claim 1 wherein the creating an authorization comprises:
creating a list of allowed commands and parameters; and
determining one or more roles of which the user is a member.

4. The method of claim 1 further comprising storing the created authorization in memory that the system can access for each command that the user executes during the lifetime of a session associated with the connection request.

5. The method of claim 3, further comprising:
creating an execution context including the created list of commands and user information associated with a session created in response to the received connection request; and
setting up impersonation so that commands invoked by the user will run as a particular user on a server that receives the commands.

6. The method of claim 5, wherein the execution context provides isolation between users of different organizations hosted on a server provided by an application service provider.

7. The method of claim 1, wherein receiving a request comprises receiving one or more commands to execute and parameters for each command specified by the user.

8. The method of claim 1 further comprising, providing a command that a client can invoke to retrieve the list of allowed commands for a user logged onto the client.

9. The method of claim 1 wherein verifying that the user has permission to execute the command comprises also verifying that the user has permission to provide received parameters and parameter values associated with each command.

10. The method of claim 1 further comprising, in response to determining that the user is not authorized to execute the command, responding to the received request with an error message indicating that the user is not authorized to execute the request.

11. The method of claim 1 wherein executing the received command comprises communicating the command to a component hosted within an application's process that performs administrative tasks offered by the application.

12. A computer system for remotely administering a hosted application, the system comprising:
a processor and memory configured to execute software instructions;
a user/role definition component configured to allow an administrator or application to define one or more users and/or roles that can access the system to invoke commands;
a command definition component configured to allow an administrator to define one or more commands that perform administrative tasks related to the hosted application;
a data store component configured to persist information about users, roles, and commands across user sessions with the system;
an authorization component configured to store information relating to authorization for an operation to be executed;
a communication component configured to provide operations to prepare communications for sending and receiving over a network between a client and the hosted application;
an authentication component configured to authenticate user sessions based on credentials supplied by the client;
a permission check component configured to validate received client requests against authorization information to verify that a user has the authority to perform a requested action; and
a user interface component configured to provide an interface for receiving commands from a user and for displaying results of executing the commands to the user.

13. The system of claim 12 wherein the command definition component is further configured to receive information identifying an executable module that the system invokes in response to a user invoking a particular command.

14. The system of claim 12 wherein the command definition component is further configured to receive one or more parameters associated with each command.

15. The system of claim 12 wherein the authorization component is further configured to store a mapping of users and roles to parameters of commands that each user or role is authorized to provide with a command.

16. The system of claim 12 wherein the communication component is further configured to use the Hypertext Transport Protocol and Simple Object Access Protocol (SOAP) to receive commands from the client to the hosted application.

17. The system of claim 12 wherein the communication component is further configured to encode the commands, serialize the data portions of the encoded commands, and fragment the serialized portions prior to transporting the commands to a server.

18. The system of claim 12 further comprising an execution context component configured to create and manage one or more execution contexts that provide an isolation environment associated with each user connected to the system, and wherein the execution context component is further configured to, after a user connects to the system and establishes a session, create an execution context associated with the user that identifies the user and the commands and other privileges associated with the user and that isolates each user and each user's privileges from those of other users.

19. A computer-readable storage medium comprising instructions for controlling a computer system to define authorization information for multiple users to remotely manage a hosted service, wherein the instructions, when executed, cause a processor to perform actions comprising:
receiving information about one or more users of the hosted service, wherein the information includes one or more roles and users associated with each role;
receiving command information that includes a module that implements each command and any parameters associated with the command;
receiving authorization information for performing an action, wherein the authorization depends on an operation to be executed;
storing the received information for later retrieval in response to received requests to execute commands from users, wherein a user connects to the system and provides authentication information that identifies the user and, in response, the system determines whether the user is authorized to invoke a requested command.

20. The medium of claim 19 wherein the receiving authorization information creates relationships between the received users and the received commands by associating commands with users and/or roles to specify the users and/or roles that are authorized to execute the commands, and wherein the receiving authorization information further comprises receiving information indicating which users and/or roles are authorized to specify one or more parameters associated with each command.
